(19) United States
(12) Patent Application Publication
(10) Pub. No.: US 2025/0117453 A1
(43) Pub. Date: Apr. 10, 2025

(54) SYSTEMS AND METHODS FOR MONITORING A DIGITAL RIGHTS MANAGEMENT TECHNOLOGY

(71) Applicant: Capital One Services, LLC, McLean, VA (US)

(72) Inventors: Jackson WESTWOOD, New York, NY (US); Daniel E. MILLER, Brooklyn, NY (US); Shahalam BAIG, Rochester, NY (US); Shasanka BHANDARI, McLean, VA (US); Matthew HUNSBERGER, Hoboken, NJ (US)

(73) Assignee: Capital One Services, LLC, McLean, VA (US)

(21) Appl. No.: 18/905,178

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/10; G06T 7/90

(52) U.S. Cl. CPC G06F 21/106; G06T 7/90; G06T 2207/10016; G06T 2207/10024

(57) ABSTRACT

A method may include receiving, using a computing device, a video from an application server. The video may include an image frame representing a first color, and may be associated with a digital rights management technology and a resolution of one pixel by one pixel. The method may include forming, using a browser module of the computing device, an HTML element including the video received from the application server. The method may include outputting, using the computing device, the video of the HTML element to a pixel of a display screen associated with the computing device. The method may include detecting, using the browser module, that the pixel is presenting the first color. The detection may represent that the digital rights management technology is disabled on the computing device; and. The method may further include transmitting, using the computing device, a notification based on the detection to the application server.

### CROSS-REFERENCE TO RELATED APPLICATION(S)

This application claims the benefit of pending U.S. Provisional Patent Application No. 63/587,891, filed on Oct. 4, 2023, pending U.S. Provisional Patent Application No. 63/665,485, filed on Jun. 28, 2024, and pending U.S. Provisional Patent Application No. 63/683,063, filed on Aug. 14, 2024, each of which is incorporated herein by reference in its entirety.

### TECHNICAL FIELD

Various embodiments of this disclosure relate generally to techniques for monitoring a digital rights management (“DRM”) technology, and more particularly to systems and methods for detecting when a DRM technology associated with a portal (e.g., a webpage, a website, an application, etc.) is disabled.

### BACKGROUND

Organizations such as banks and healthcare providers seek to protect sensitive information (e.g., confidential information, personally identifiable information, financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, the target may be a user who uses a display screen of a computing device to view a webpage of a bank. More specifically, the user may view the user's checking account balance on the bank's webpage, within a browser window presented on the display screen. A social engineer using another computing device may persuade the user to screenshare the user's display screen so that the social engineer can view the user's checking account balance.

To prevent the social engineer from viewing the user's checking account balance during the screensharing, the bank may employ digital rights management (“DRM”) technologies, which are technologies that limit the use of digital content. However, if the DRM technologies are disabled or circumvented, the bank may not immediately know that the social engineer is viewing the user's checking account balance, and that associated resources, such as the user's checking account, may be at risk.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for monitoring a DRM technology associated with a portal (e.g., a webpage, a website, an application, etc.), and detecting when the DRM technology is disabled, are disclosed. Each of the examples disclosed herein may include one or more features described in connection with any of the other disclosed examples.

In one aspect, an exemplary embodiment of a method may include receiving, using a computing device, a video from an application server. The video may include an image frame representing a first color, and may be associated with a digital rights management technology and a resolution of one pixel by one pixel. The method may include forming, using a browser module of the computing device, a HyperText Markup Language (HTML) element including the video received from the application server. The method may include outputting, using the computing device, the video of the HTML element to a pixel of a display screen associated with the computing device. The method may include detecting, using the browser module, that the pixel is presenting the first color. The detection may represent that the digital rights management technology is disabled on the computing device. The method may further include transmitting, using the computing device, a notification based on the detection to the application server.

In another aspect, an exemplary embodiment of a system may include at least one processor and at least one memory having programming instructions stored thereon, which, when executed by the at least one processor, cause the system to perform operations. The operations may include receiving, using a computing device, a video from an application server. The video may include an image frame representing a first color. Further, the video may be associated with a digital rights management technology and a resolution of one pixel by one pixel. The operations may include forming, using the computing device, a HyperText Markup Language (HTML) element including the video received from the application server. The operations may include outputting, using the computing device, the video of the HTML element to a pixel of a display screen associated with the computing device. The operations may include detecting, using the computing device, that the pixel is presenting the first color. The detection may represent that the digital rights management technology is disabled on the computing device. The operations may include transmitting, using the computing device, a notification based on the detection to the application server.

In a further aspect, an exemplary embodiment of a method may include receiving, using a computing device, a video from an application server. The video may include an image frame representing a color. The video may be associated with a digital rights management technology and a resolution of one pixel by one pixel. The method may include forming, using a browser module of the computing device, a HyperText Markup Language (HTML) element including the video received from the application server. The method may include outputting, using an operating system of the computing device, the video of the HTML element to a pixel of a display screen associated with the computing device. The method may include detecting, using an application programming interface of the browser module, that the pixel is presenting the color, where the detection represents that the digital rights management technology is disabled on the computing device. The method may further include transmitting, using the computing device, a notification based on the detection to the application server.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an example environment, according to one or more embodiments.

FIG. 2 depicts a flow diagram of an example method, according to one or more embodiments.

FIG. 3 depicts an example computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of +10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, the term “window” may refer to a region on a display screen in which data (e.g., text data, image data, etc.) is presented using one or more pixels. The term “browser window” herein may refer to a window in which a web browser is displayed and through which a user may access and view websites, webpages, web applications, or other content available on the internet. The term “viewport” herein may refer to an area, region, or portion of a webpage or website that is presented within a browser window (or visible to a user viewing the browser window) on a display screen.

As used herein, the term “pixel” may refer to the smallest element (or unit) of a display screen that can be programmed by (or manipulated through) software. In some embodiments, a pixel may include sub-pixels (e.g., a red sub-pixel, a green sub-pixel, and a blue sub-pixel) that emit light to create a color displayed on the display screen. In some aspects, the color may be included in, or represent, text data, image data, or video data presented on the display screen.

As used herein, the term “HTML page” may refer to a file that includes HTML, and that defines the structure and content of a webpage or website. An HTML element may represent a component of an HTML page, and may include, for example, a start tag, an end tag, a content element, or a reference to a content element (e.g., a link, hyperlink, address, or path to a content element). In some embodiments, an HTML element may include one or more HTML elements (e.g., nested HTML elements).

As used herein, the term “screenshare” may refer to a real time or near real time electronic transmission of data displayed on a display screen of a user's computing device to one or more other computing devices. The term “screensharing” and the phrase “being screenshared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” may represent an image of data displayed on a display screen of a computing device, where the image may be captured or recorded. The term “screenshotting” and the phrase “being screenshotted” may refer to capturing or recording a screenshot. In some aspects, screenshotting may be performed using a screenshotting application (e.g., the Snipping Tool in Microsoft's Windows 11® or an application accessed using a Print Screen key of a keyboard or keypad).

In the following description, embodiments will be described with reference to the accompanying drawings. As will be discussed in more detail below, various embodiments, methods, and systems for monitoring a DRM technology associated with a portal (e.g., a webpage, a website, an application, etc.), and detecting when the DRM technology is disabled, are described.

In an exemplary use case, a customer of a bank may use a computing device, such as a desktop computer (also referred to herein as the “computer”), to obtain financial information, where the computer includes specialized hardware configured to accelerate data processing (or perform hardware acceleration). More specifically, the customer may use the computer to navigate to a webpage that is associated with the bank, and on which the customer anticipates viewing the customer's checking account balance. During the navigation, the computer may receive, from an application server associated with the bank, an HTML page that represents the webpage. The computer may also receive, from the application server, a first video that includes an image frame representing the customer's checking account balance, where the first video is protected by a DRM technology. For example, the DRM technology may be configured to protect the first video by preventing (or blocking) the first video from playing on a display screen (associated with the computer) that is being screenshared with, or screenshotted for, a social engineer or potential social engineer. In some embodiments, the first video may be configured to play the image frame in a loop. The computer may further receive, from the application server, a second video that includes an image frame representing a first color (e.g., black), where the second video is protected by the DRM technology. In some aspects, the second video may have a resolution of one pixel by one pixel, and be configured to play the image frame representing the first color in a loop. The computer may further form, for example, a first HTML element that includes the first video and form a second HTML element that includes the second video, and the computer may incorporate the first and second HTML elements in the HTML page.

Subsequently, the webpage and the first and second videos of the HTML page may be output to, and presented on, the display screen. More specifically, the first and second videos may be overlaid on the webpage such that, from the perspective of the customer viewing the display screen, the first and second videos are positioned in front of the webpage on the display screen. In some embodiments, the first and second videos may not overlap one another on the display screen. Further, the second video may be presented using a single pixel of the display screen. However, unbeknownst to the customer, the specialized hardware configured to accelerate data processing may be disabled, and as a result, the DRM technology used to protect the first and second videos may be disabled or not work properly on the computer. Further, the first and second videos may begin to play on the display screen. Subsequently, the computer may detect that the pixel used to play the second video is presenting (or emitting) the first color (e.g., black). Consequently, the computer may transmit a notification regarding the detection to the application server to inform the bank that the DRM technology is not operating properly on the computer, and that the user's checking account balance is at risk of being viewed or accessed by a social engineer or potential social engineer

Upon receiving the notification, the bank (or the application server) may perform one or more security measures to protect the customer's checking account balance and associated resources such as the customer's checking account, and any debit cards associated with the customer's checking account. For example, the application server may monitor the customer's checking account more closely, or flag or freeze any subsequent transactions involving the customer's checking account (or associated debit cards) that appear unusual, suspicious, or high-risk. In addition or in the alternative, the application server may transmit a notification to the customer's computer for presentation on the display screen, where the notification warns the customer that the checking account balance presented on the bank's webpage is not secured.

Accordingly, embodiments described herein may be used to detect when a DRM technology that is used to protected content of a webpage (or other portal), becomes comprised or disabled. As a result, an organization or entity associated with the webpage (e.g., a bank) can take measures to enhance the security of the webpage and any resources associated with the webpage.

While the example above involves a webpage and a checking account balance, it should be understood that techniques according to this disclosure may be adapted to any suitable type of program (e.g., a website, portal, application, browser extension, plugin, etc.) and content (e.g., content associated with an intelligent authentication method or system, sensitive information, non-sensitive information, text data, image data, audio data, web applications, etc.), respectively. Further, while the example above involves two videos that are protected by a DRM technology when the DRM technology is enabled, it should be understood that techniques according to this disclosure may be adapted to one or more videos that are protected by a DRM technology when the DRM technology is enabled. It should also be understood that the example above is illustrative only. The techniques and technologies of this disclosure may be adapted to any suitable activity.

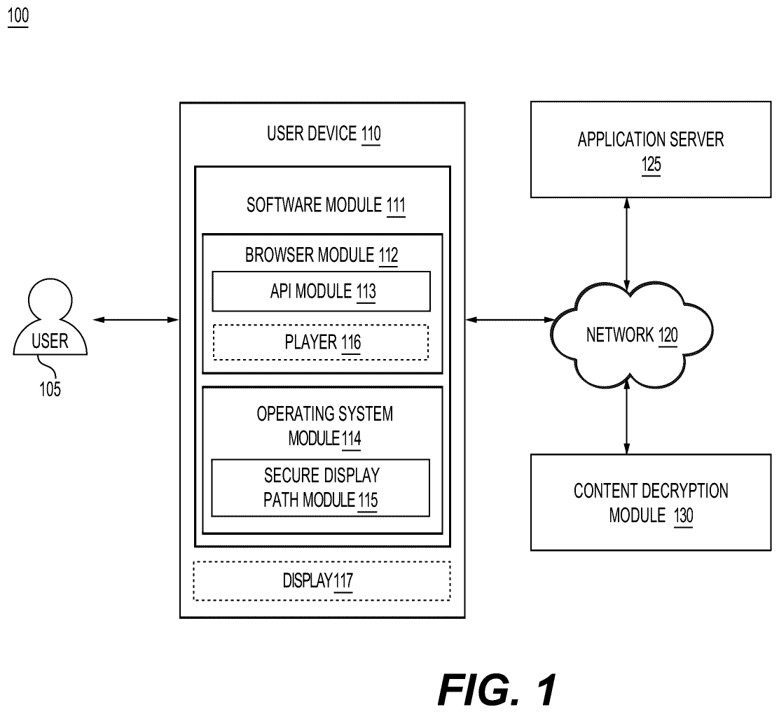

FIG. 1 depicts an example environment 100 that may be utilized with techniques presented herein. In some aspects, the environment 100 may be an embodiment of (i) the environment 100 described in U.S. Provisional Application 63/587,891, filed on Oct. 4, 2023, (ii) the environment 100 described in U.S. Provisional Application 63/665,485, filed Jun. 28, 2024, or (iii) the environment 100 described in U.S. Provisional Application 63/683,063, filed Aug. 14, 2024, where each of these U.S. provisional applications is incorporated by reference herein in its entirety. As shown in FIG. 1, the environment 100 may include a user device 110, a network 120 (e.g., an electronic network), an application server 125, and a content decryption model 130 (also referred to herein as the “CDM 130”). In some aspects, the user device 110, the application server 125, and the CDM 130 may communicate with one another in any arrangement across the network 120. The user device 110 may be associated with a user 105. In some embodiments, the user 105 may be a customer or employee of, or contractor for, a company, business, organization (e.g., a bank, a hospital, a university, etc.), or the like. Further, in some embodiments, the company, business, or organization may be associated with (e.g., own, rent, or control) the user device 110. In some other embodiments, the user 105 may own, rent, or control the user device 110. Further, in some embodiments, the user 105 may be an authorized user of the user device 110 and a portal (e.g., a webpage, website, or application) accessed using the user device 110.

The user device 110 may be configured to enable the user 105 to access or interact with the network 120, the application server 125, and the CDM 130, in the environment 100. For example, the user device 110 may be a computer system such as a desktop computer, a laptop, a workstation, a mobile device, a tablet, etc. In some embodiments, the user device 110 may include one or more software modules, which may represent electronic application(s) such as a program, a platform, a plugin, or a browser extension, installed on a memory of the user device 110. For example, as shown in FIG. 1, the user device 110 may include a software module 111 that may represent (or include), for example, a browser module 112, an operating system module 114, and optionally a player 116.

The player 116 may represent a video player configured to play back one or more videos, or present image frames (or video frames) of one or more videos on a display screen (e.g., the display 117). In some embodiments, and as shown in FIG. 1, the player 116 may be included in the browser module 112. In some other embodiments, the player 116 may be included in the operating system module 114, or the player 116 may represent hardware included in the user device 110 (not shown in FIG. 1). In some embodiments, the player 116 may represent an interactive video player, which is a video player configured to play back a video, where a user (e.g., the user 105) may interact with the video (e.g., by selecting a button presented in the video) during the playback on a display screen (e.g., the display 117).

In some embodiments, the user device 110 may include the display 117, which may represent a display screen configured to display or present data, optionally using the player 116. In some aspects, the display 117 may include pixels, where a pixel may represent the smallest element (or unit) of the display 117 that can be programmed by (or manipulated through) software. In some embodiments, a pixel may include sub-pixels (e.g., a red sub-pixel, a green sub-pixel, and a blue sub-pixel) that emit light to create a color displayed on the display 117. In some aspects, the color may be included in, or represent, text data, image data, or video data presented on the display 117. In some aspects, the display 117 may receive data for display from the browser module 112 or the operating system module 114.

The browser module 112 may include one or more browsers (e.g., web browsers or applications for accessing and viewing content on the internet, the World Wide Web, a cloud platform, etc.). For example, the browser module 112 may include one or more web browsers such as Google Chrome®, Microsoft Edge®, Firefox®, Safari®, or Opera®. In some embodiments, the browser module 112 may be configured to communicate with the operating system module 114, the player 116, the display 117, the network 120, and the application server 125 and the CDM 130, via the network 120. For example, in response to the user 105 inputting a web address (or uniform resource locator) to the browser module 112 (e.g., using the display 117 or a keyboard or other input/output device associated with the user device 110), the browser module 112 may be configured to transmit a request for a webpage (or website, portal, application, etc.) associated with the web address, to the application server 125 via the network 120. The browser module 112 may also be configured to receive the webpage (e.g., an HTML page corresponding to the webpage) from the application server 125 via the network 120. In some aspects, the browser module 112 may be configured to load, render, or output the webpage (or a portion of the webpage) to the display 117 directly, or indirectly via the operating system module 114, for display within a web browser. Further, the browser module 112 (or webpage or web application associated with an HTML page of the browser module 112) may be configured to record, log, or store data representing color(s) emitted by, or associated with, one or more pixels of the display 117, in a storage component (e.g., a memory) of the user device 110 (not shown in FIG. 1).

As shown in FIG. 1, the browser module 112 may include an application programming interface module 113 (also referred to herein as the “API module 113”). In some aspects, the API module 113 may be configured to communicate or interface with, for example, the browser module 112 (e.g., a browser), an HTML page of the browser module 112, the operating system module 114, or the application server 125 via the network 120. For example, in response to receiving (or being triggered by) an API request (or API call) from an HTML page representing a webpage in the browser module 112, the API module 113 may subsequently interact with a browser of the browser module 112. Further, the API module 113 may be configured to receive and respond to a request for information (e.g., a request for color(s) emitted by, or associated with, one or more pixels of the display 117) from the browser module 112 (or a webpage or web application associated with an HTML page of the browser module 112). Further, the API module 113 may be configured to test (or sample) the color of a pixel of any video that is associated with a DRM technology and presented on the display 117, to determine whether the DRM technology is enabled or disabled (or working properly or not). In some embodiments, API module 113 may include one or more applications configured to detect, monitor (or track), or record color(s) emitted by, or associated with, one or more pixels of the display 117. For example, the API module 113 may include the chrome.tabs captureVisibleTab API, where the browser module 112 includes Google Chrome®. As another example, the API module 113 may include the EyeDropper API. In some embodiments, the API module 113 (or the browser module 112) may be configured to receive an indication from the user 105 (e.g., using a keyboard, mouse, trackpad, or touchscreen associated with the user device 110) that the user 105 consents to the API module 113 detecting, monitoring, or recording, color(s) emitted by, or associated with, one or more pixels of the display 117.

In some embodiments, in response to receiving a request from (or being triggered by) a web application included in an HTML page of the browser module 112, the API module 113 may automatically detect, monitor, or record (e.g., in a storage component of the user device 110) color(s) emitted by, or associated with, one or more pixels of the display 117. Further, in some embodiments, in response to receiving a request from (or being triggered by) a web application included in an HTML page of the browser module 112, the API module 113 may detect, monitor, or record (e.g., in a storage component of the user device 110) color(s) emitted by, or associated with, one or more pixels of the display 117 upon determining that a position of a cursor presented on the display 117 is proximate to, or coincides with, a position of at least one of the one or more pixels. For example, in response to (i) the API module 113 receiving a request from a web application of an HTML page of the browser module 112, and (ii) the user device 110 determining that a cursor presented on the display 117 is positioned over a button or dropdown menu that is proximate to a position of a particular (or designated) pixel (or multiple designated pixels) of the display 117, the API module 113 may detect, monitor, or record a color emitted by, or associated with, the pixel (or multiple designated pixels).

In some embodiments, the API module 113 may be configured to detect, monitor, or record color(s) emitted by, or associated with, one or more pixels used to display one or more videos at different locations on the display 117, where each of the one or more videos may have a resolution of at least one pixel by one pixel and include an image frame representing (or depicting) a respective color. In some embodiments, each of the one or more videos may include only one image frame and represent a single frame-looped video. For example, the API module 113 may be configured to detect, monitor, or record a color emitted by, or associated with, a pixel used to display a video with a resolution of one pixel by one pixel, where the video is overlaid on a webpage presented on the display 117. In some embodiments, a user viewing the display 117 (e.g., the user 105) may not be able to see (or readily see) the video on the display 117 because of the video's small resolution. Further, in some aspects, the video may include only one image frame, where the image frame depicts (or represents) a first color (e.g., black). The first color may be different (or sufficiently different) from a second color (e.g., white) of a region of the webpage on which the video is overlaid on the display 117. In some aspects, the video may be configured to play the image frame in a loop on the display 117. As another example, the API module 113 may be configured to detect, monitor, or record a color emitted by, or associated with, a set of pixels used to display a video A with a resolution of at least one pixel by at least one pixel, where the video A is overlaid on (e.g., to entirely cover) a video B (which may or may not be overlaid on a webpage) presented on the display 117. In some aspects, the video B may have a resolution that is the same as or smaller than the resolution of the video A. In some aspects, the video A may include only one image frame, and be configured to play the image frame in a loop on the display 117.

In some aspects, a video may be associated with a DRM technology that may be enabled or disabled on the user device 110 (or the browser module 112). More specifically, the video may be protected by the DRM technology when the DRM technology is enabled (or working properly) on the user device 110 (e.g., where any specialized hardware installed on the user device 110 to accelerate data processing, or perform hardware acceleration, is enabled). For example, the video may be configured to not play, or be blocked from playing, due to the DRM technology (and a secure display path module 115), when the display 117 is being screenshared or screenshotted. Further, the video may not be protected (or not be fully protected) by the DRM technology when the DRM technology is not enabled (or disabled or not working properly) on the user device 110 (e.g., where any specialized hardware installed on the user device 110 to accelerate data processing is enabled).

In some embodiments, when (i) the DRM technology is enabled on the user device 110 and (ii) the video is being played on the display 117, the API module 113 may record the second color (e.g., white) of the region of the webpage on which the video is overlaid. In such embodiments, the second color (e.g., white) is associated with—but not emitted by—the pixel being used to present or display the image frame depicting the first color (e.g., black) of the video on the display 117. Further, when (i) the DRM technology is disabled on the user device 110 and (ii) the video is playing on the display 117, the API module 113 may detect, monitor (e.g., track), or record the first color (e.g., black) of the image frame of the video, being emitted by the pixel. In some aspects, the detection, monitoring, or recording of the first color of the image frame may represent that the DRM technology is disabled on the user device 110. Further, in some embodiments, to verify the first color detected, monitored or recorded, the API module 113 may compare the first color to an average of the color(s) being emitted by one or more pixels proximate (and optionally orthogonal) to the pixel. Where the API module 113 determines a threshold difference between the first color and the average of the color(s), the API module 113 may determine that the first color detected, monitored, or recorded, is accurate.

In response to detecting, monitoring, or recording (and optionally verifying) the first color of the image frame being emitted by the pixel, the API module 113 may generate a notification indicating that the first color of the image frame was emitted by the pixel (or that the DRM technology is disabled). The API module 113 may further transmit the notification to the application server 125 via the network 120. Accordingly, the first color emitted by the pixel may serve as a flag or warning that the DRM technology is not working properly on the user device 110 and that any information presented on the webpage (e.g. by other pixels of the display 117) may be visible to or accessible by a social engineer (even if the information is supposed to be protected by the DRM technology).

In some aspects, when the browser module 112 receives a webpage (e.g., an HTML page corresponding to a webpage) from the application server 125, the webpage may include (or represent) one or more content elements. In some aspects, a content element may represent content or data such as text data (e.g., letters, numbers, symbols, metadata, or alt text), image data (e.g., an image, a graphic, a sequence of image frames, or a video), or audio data (e.g., a sequence of audio frames). In some embodiments, a content element may be dynamic (e.g., configured to change over time), such as an animated graphic or a video advertisement. Further, in some embodiments, a content element may be interactive (e.g., configured to respond to an input from a user of a computing device), such as a button, a toggle switch, a field configured to display text, a link (e.g., a hyperlink), an icon that may be selected to launch an application, text that may be highlighted or selected (e.g., using a cursor), or one or more images that may be highlighted or selected (e.g., using a cursor). In some aspects, a content element may include one or more content elements. Further, a content element may represent data included in, or referred by, an HTML element of an HTML page corresponding to (or representing) the webpage. An HTML element may represent a component of an HTML page, and may include, for example, a start tag, an end tag, and as noted above, a content element or a reference to a content element (e.g., a link, hyperlink, address, or path to a content element). Further, in some embodiments, an HTML element may include one or more HTML elements (e.g., nested HTML elements).

In some embodiments, one or more content elements of the webpage may include sensitive information or non-sensitive information. In some aspects, sensitive information may refer to data that is intended for, or restricted to the use of, one or more users or entities (e.g., the user 105 and an organization associated with the application server 125). Moreover, sensitive information may represent data that is personal, private, confidential, privileged, secret, classified, or in need of protection. Sensitive information may further represent, for example, financial data such as account numbers, credit card account numbers, checking account numbers, savings account numbers, virtual card numbers, account balances, credit card account balances, checking account balances, savings account balances, financial statements, ledgers, bills, or invoices; personally identifiable information such as a name, address, phone number, social security number, or driver's license number; passport information, medical information such as a patient's medical history, a doctor's summary or diagnosis, or medical test results; academic information such as a student's grades or transcript; business information such as trade secrets, proprietary information, or business strategy information; governmental information such as classified or secret information related to national security or defense; or data that is copyrighted, etc.

In some embodiments, the browser module 112 may be configured to determine whether one or more content elements of the webpage include sensitive information. The browser module 112 may also be configured to transmit this determination to the application server 125 via the network 120. In some embodiments, the browser module 112 may be configured to receive one or more content elements of the webpage from the application server 125, optionally via the CDM 130. For example, the browser module 112 may be configured to receive a DRM-protected video that includes an image frame (or video frame) depicting the one or more content elements of the webpage, from the application server 125 via the CDM 130. The browser module 112 may also be configured to communicate with the operating system module 114. For example, the browser module 112 may be configured to transmit one or more content elements (e.g., a DRM-protected video or other data) to the operating system module 114 (e.g., via a secure display path module 115).

In some embodiments, the operating system module 114 may include one or more operating systems. In some aspects, an operating system may represent software configured to (i) manage hardware and software resources of the user device 110 or (ii) provide services for applications associated with the user device 110. Further, the operating system module 114 may be configured to communicate with the browser module 112, the player 116, the display 117, and the application server 125 and the CDM 130, via the network 120. In some embodiments, the operating system module 114 may include the secure display path module 115 (also referred to herein as the “secure display path 115”). In some aspects, the secure display path 115 may represent (or include) one or more DRM technologies (or DRM functions) used to protect or secure content element(s) that the secure display path 115 receives (or retrieves) from the browser module 112, the application server 125, or the CDM 130. The secure display path 115 may be native (or specific) to a respective operating system of the operating system module 114. In some embodiments, the secure display path 115 may represent Microsoft's Protected Media Path, for example.

In some aspects, the secure display path module 115 may be configured to load, render, or output to the display 117, one or more content elements of a webpage for presentation, optionally while the browser module 112 concurrently loads, renders, or outputs to the display 117, the remainder (or a portion of) of the webpage for presentation. For example, where a content element of a webpage represents a DRM-protected video that has a resolution of one pixel by one pixel, and includes an image frame depicting a first color (e.g., black), the secure display path module 115 may load, render, or output the DRM-protected video to a pixel of the display 117 for presentation in a viewport, while the browser module 112 concurrently loads, renders, or outputs to the display 117, the remainder (or a portion) of the webpage (e.g., a portion of the webpage that excludes the DRM-protected video) for presentation in the viewport. In some aspects, where the DRM-protected video includes an image frame representing a first color (e.g., black), the DRM-protected video may be configured to be overlaid on a region of the webpage representing a second color (e.g., white).

As another example, where a content element of a webpage represents a DRM-protected video that includes an image frame depicting sensitive information (e.g., a checking account balance), the secure display path module 115 may load, render, or output the DRM-protected video to the display 117 for presentation in a viewport, while the browser module 112 concurrently loads, renders, or outputs to the display 117, the remainder (or a portion) of the webpage (e.g., a portion of the webpage that excludes the DRM-protected video and the sensitive information) for presentation in the viewport. In some embodiments, the DRM-protected video may be presented over background color(s) of the remainder (or a portion) of the webpage presented in the viewport, on the display 117.

As another example, where a first content element of a webpage represents a DRM-protected video that includes only one image frame, where the image frame is transparent (and does not depict or represent sensitive information) and where a second content element of the webpage represents sensitive information (e.g., a checking account balance), the secure display path module 115 may load, render, or output the first and second content elements to the display 117 for presentation in a viewport, while the browser module 112 loads, renders, or outputs to the display 117, the remainder (or a portion) of the webpage for presentation in the viewport. In some aspects, the first content element (the DRM-protected video including the transparent image frame) may be presented on top of (or be overlaid on) the second content element (the sensitive information), which may be overlaid on the remainder (or a portion) of the webpage presented in the viewport. Further, when the first content element (the DRM-protected video including the transparent image frame) is played on the display 117 (e.g., in a loop), the user 105 may view the second content element (the sensitive information) presented under the first content element on the display 117. As used herein, the terms “image frame that is transparent” and “transparent image frame” refer to an image frame of a video, where the image frame is clear (e.g., see-through or invisible, from the perspective of a user viewing the image frame on the display 117), and does not depict or represent any sensitive information. As yet another example, where a content element of a webpage represents a DRM-protected video that includes an image frame that depicts the entire webpage, the secure display path module 115 may load, render, or output the content element to the display 117 for presentation within a viewport.

In some aspects, the secure display path 115 may be configured to protect (or secure) one or more content elements (e.g., one or more pre-determined or pre-selected content elements) by blocking or preventing the one or more content elements from being loaded, rendered, or output to or played on the display 117, when the display 117 is being screenshared (e.g., using a remote desktop application or screensharing) or screenshotted (e.g., using a screenshotting application), and when a DRM technology associated with the one or more content elements is enabled on the user device 110. Further, the secure display path 115 may be configured to load, render, output to, or support the playing of (e.g., using the player 116), one or more content elements on the display 117 when the display 117 is not being screenshared or screenshotted.

The application server 125 may be a computing system such as a server, a workstation, a desktop computer, a laptop, a mobile device, a tablet, etc. In some examples, the application server 125 may be associated with (or include) a cloud computing platform with scalable resources for computation or data storage. The application server 125 may run one or more applications locally or using the cloud computing platform, to perform various computer-implemented methods described in this disclosure. In some embodiments, the application server 125 may be associated with (e.g., owned, rented, or controlled by) a company, a business, or an organization, such as a bank, a hospital, a university, or a merchant, etc. In some aspects, the application server 125 may be configured to communicate with the user device 110 and the CDM 130, via the network 120.

For example, the application server 125 may be configured to transmit an HTML page (or file) corresponding to a webpage to the browser module 112 or the operating system module 114, via the network 120. In some embodiments, the application server 125 may be configured to receive a notification (or determination) from the browser module 112 that one or more content elements of the HTML page include sensitive information. Further, in some embodiments, the application server 125 may be configured to determine whether one or more content elements of the HTML page (or webpage) include sensitive information. In response to determining (or receiving a determination) that a content element includes sensitive information, the application server 125 may generate and encrypt a DRM-protected video that includes either (i) a transparent image frame configured to be presented over the sensitive information on the display 117 or (ii) an image frame that depicts or represents the sensitive information. In some aspects, the application server 125 may be configured to transmit the encrypted, DRM-protected video to the CDM 130 (which may decrypt the encrypted DRM-protected video and transmit the decrypted DRM-protected video to the user device 110).

Further, in some aspects, the application server 125 may be configured to receive one or more notifications from the user device 110 (e.g., the browser module 112 or the API module 113) that a DRM technology is disabled on the user device 110. Put differently, the application server 125 may be configured to receive one or more notifications from the user device 110 that one or more pixels of the display 117 are emitting color(s) of videos, where the emitted color(s) represent that a DRM technology is disabled on the user device 110. Because such a notification indicates that content or sensitive information (e.g., a checking account number) of a webpage being presented on the display 117 is at risk of being shared with a social engineer, in response to receiving the notification, the application server 125 may determine one or more security measures to perform in order to mitigate the risk. For example, the application server 125 may determine to perform (or initiate) one or more of the following security measures: (i) cause resources associated with the webpage (or portal) to be more closely tracked or monitored, or be locked or frozen, for a fixed period of time or indefinitely; (ii) log data (or increase logging of data) concerning the user 105's or another person's or entity's usage of the webpage; (iii) impose limitations or restrictions on any features or resources (e.g., accounts, data, or data profiles, etc.) associated with, or referenced, in the webpage or any DRM-protected videos overlaid on the webpage on the display 117 (e.g., disable sensitive features associated with the webpage); (iv) automatically issue a new credit card or data (e.g., security pins or passwords) to the user 105; (v) freeze any wire transfers or transactions involving account(s) associated with, or referenced in, the webpage or any DRM-protected videos overlaid on the webpage on the display 117; (vi) render obsolete any virtual card numbers associated with, or referenced in, the webpage or any DRM-protected videos overlaid on the webpage on the display 117; (vii) modify (e.g., increase) any fraud alerts related to any accounts associated with, or referenced in, the webpage or any DRM-protected videos overlaid on the webpage on the display 117, thereby causing any credit cards, debit cards, or virtual cards associated with the accounts to be declined more often; or (viii) transmit a notification to the user device 110 for display on the display 117, where the notification may inform the user 105 that content of the webpage presented on the display 117 is unprotected and therefore vulnerable to being viewed or accessed by a social engineer (e.g., though screensharing or screenshotting the webpage displayed on the display 117 with a social engineer). In some embodiments, the notification may represent a fraud alert and be transmitted from the application server 125 to other devices, or other portals, associated with the user 105.

In some aspects, the CDM 130 (or DRM platform 130) may be configured to communicate with the user device 110 and the application server 125, via the network 120. For example, the CDM 130 may be configured to receive an encrypted, DRM-protected video from the application server 125. The CDM 130 may also be configured to decrypt the encrypted, DRM-protected video, and transmit the decrypted, DRM-protected video to the user device 110 (e.g., to the browser module 112 or the operating system module 114).

In various embodiments, the network 120 may be a wide area network (“WAN”), a local area network (“LAN”), personal area network (“PAN”), or the like. In some embodiments, network 120 may include the Internet, and support the transmission of information and data between various systems online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page,” “website,” or “webpage” generally encompasses a location, data store, or the like that is, for example, hosted or operated by a computer system so as to be accessible online, and that may include data configured to cause a program such as a browser to perform operations such as send, receive, or process data, generate a visual display or an interactive interface, or the like.

Although depicted as separate components in FIG. 1, it should be understood that a component or portion of a component in the environment 100 may, in some embodiments, be integrated with or incorporated into one or more other components. For example, in some embodiments, at least a portion of the application server 125 or the CDM 130 may be integrated into the user device 110. In some embodiments, operations or aspects of one or more of the components discussed above may be distributed amongst one or more other components. Any suitable arrangement or integration of the various systems and devices of the environment 100 may be used. Further, in some embodiments, the environment 100 may include multiple user devices 110, multiple application servers 125, or multiple CDMs 130.

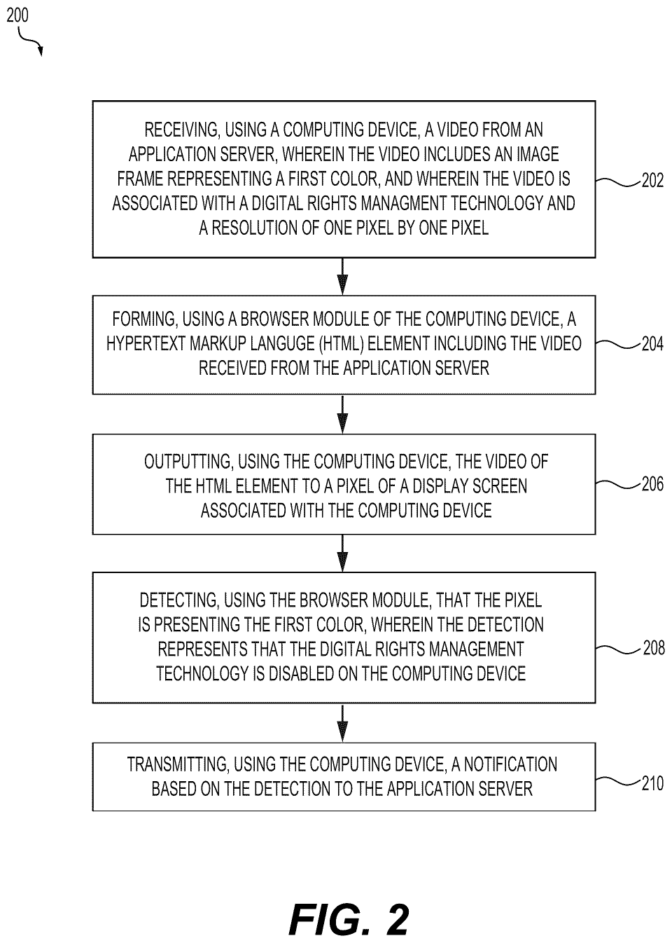

FIG. 2 depicts a flow diagram of an example method for monitoring a DRM technology, according to one or more embodiments presented herein. More specifically, FIG. 2 depicts a flow diagram of a method 200 for detecting when a DRM technology associated with a portal (e.g., a webpage, a website, an application, etc.) is disabled. In some aspects, the method 200 may be performed by the user device 110.

As shown in FIG. 2, the method 200 may include receiving, using a computing device (e.g., the user device 110), a video from an application server (e.g., the application server 125), where the video includes an image frame representing a first color (e.g., black), and where the video is associated with a digital rights management technology and a resolution of one pixel by one pixel (202) (or alternatively a resolution of at least one pixel by at least one pixel, or an arbitrary number of pixels). In some embodiments, the video may include only one image frame. Further, the video may be configured to play in a loop on a display screen (e.g., the display 117).

The method 200 may include forming, using a browser module (e.g., the browser module 112) of the computing device, a HyperText Markup Language (HTML) element including the video received from the application server (204). In some embodiments, the HTML element may be included in an HTML page that corresponds to (or represents) a webpage.

The method 200 may include outputting, using the computing device (e.g., the browser module 112 or the operating system module 114), the video of the HTML element to a pixel of a display screen (e.g., the display 117) associated with the computing device (206). In some embodiments, the method 200 may further include outputting, using the browser module of the computing device, at least a portion of a webpage including a region representing a second color (e.g., white), where the video is configured to be overlaid on the second color of the region on the display screen. Further, in some embodiments, the method 200 may include detecting a position of a cursor presented on the display screen, the position being proximate to a position of the pixel. The method 200 may also include monitoring, using the browser module, a color presented by, or associated with, the pixel in response to detecting the position of the cursor presented on the display screen.

The method 200 may include detecting, using the browser module (e.g., the API module 113), that the pixel is presenting the first color (e.g., black), where the detection represents that the digital rights management technology is disabled on the computing device (208). In some embodiment, the method 200 may further include recording, using the computing device and in response to the detection, the first color being presented by the pixel. In some embodiments, the method 200 may further include transmitting, using the computing device, a notification based on the detection to the application server (210).

In general, any process or operation discussed in this disclosure that is understood to be computer-implementable, such as the process (or method) illustrated in FIG. 2, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

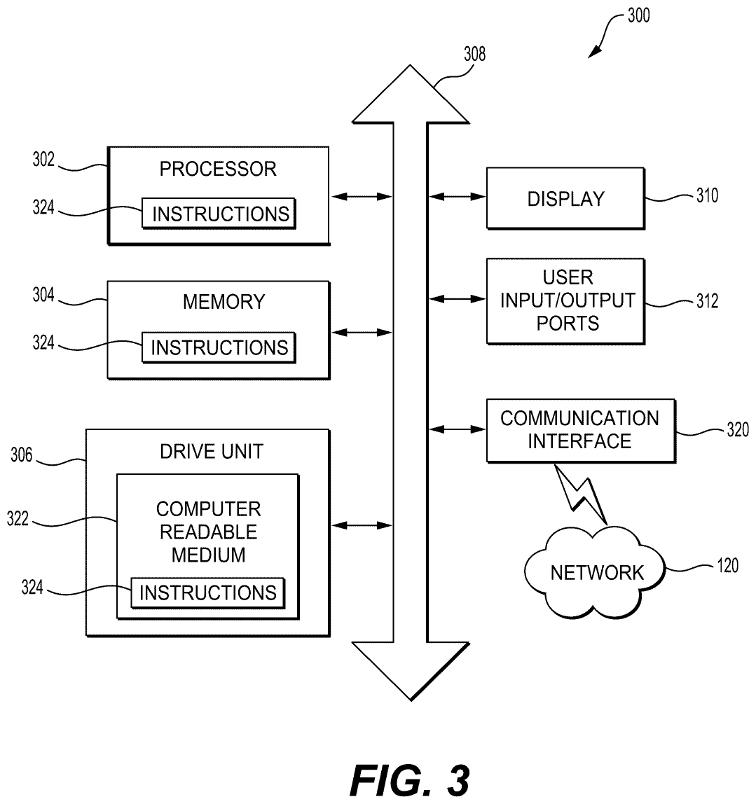

FIG. 3 is a simplified functional block diagram of a computer 300 that may be configured as a device for executing the method 200 of FIG. 2, according to exemplary embodiments of the present disclosure. For example, in some embodiments, the computer 300 may be configured as the user device 110, according to exemplary embodiments of this disclosure. In some other embodiments, the computer 300 may be configured as the application server 125, according to exemplary embodiments of this disclosure. In some other embodiments, the computer 300 may be configured as the CDM 130, according to exemplary embodiments of this disclosure. In various embodiments, any of the devices or systems herein may be a computer 300 including, for example, a data communication interface 320 for packet data communication. The computer 300 also may include a central processing unit (“CPU”) 302, in the form of one or more processors, for executing program instructions. The computer 300 may include an internal communication bus 308, and a storage (or drive) unit 306 (such as ROM, HDD, SDD, etc.) that may store data on a computer readable medium 322, although the computer 300 may receive programming and data via network communications. The computer 300 may also have a memory 304 (such as RAM) storing instructions 324 for executing techniques presented herein, although the instructions 324 may be stored temporarily or permanently within other modules of computer 300 (e.g., processor 302 or computer readable medium 322). The computer 300 also may include input and output ports 312 or a display (or display screen) 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method comprising:
receiving, using a computing device, a video from an application server, wherein the video includes an image frame representing a first color, and wherein the video is associated with a digital rights management technology and a resolution of one pixel by one pixel;
forming, using a browser module of the computing device, a HyperText Markup Language (HTML) element including the video received from the application server;
outputting, using the computing device, the video of the HTML element to a pixel of a display screen associated with the computing device;
detecting, using the browser module, that the pixel is presenting the first color, wherein the detection represents that the digital rights management technology is disabled on the computing device; and
transmitting, using the computing device, a notification based on the detection to the application server.

2. The method of claim 1, wherein detecting, using the browser module, that the pixel is presenting the first color comprises:
detecting, using an application programming interface of the browser module, that the pixel is presenting the first color.

3. The method of claim 1, further comprising:
outputting, using the browser module of the computing device, at least a portion of a webpage including a region representing a second color, wherein the video is configured to be overlaid on the second color of the region on the display screen.

4. The method of claim 1, further comprising:
monitoring, using the browser module, a color presented by the pixel.

5. The method of claim 1, further comprising:
detecting a position of a cursor presented on the display screen, the position being proximate to a position of the pixel; and
monitoring, using the browser module, a color presented by the pixel in response to detecting the position of the cursor presented on the display screen.

6. The method of claim 1, further comprising:
recording, using the computing device and in response to the detection, the first color being presented by the pixel.

7. The method of claim 1, wherein outputting, using the computing device, the video to the pixel of the display screen associated with the computing device comprises:
outputting, using an operating system of the computing device, the video to the pixel of the display screen associated with the computing device.

8. The method of claim 1, wherein the video includes only one image frame.

9. The method of claim 1, wherein the video is configured to play in a loop on the display screen.

10. A system comprising:
at least one processor; and
at least one memory having programming instructions stored thereon, which, when executed by the at least one processor, cause the system to perform operations comprising:
receiving, using a computing device, a video from an application server, wherein the video includes an image frame representing a first color, and wherein the video is associated with a digital rights management technology and a resolution of one pixel by one pixel;
forming, using the computing device, a HyperText Markup Language (HTML) element including the video received from the application server;
outputting, using the computing device, the video of the HTML element to a pixel of a display screen associated with the computing device;
detecting, using the computing device, that the pixel is presenting the first color, wherein the detection represents that the digital rights management technology is disabled on the computing device; and
transmitting, using the computing device, a notification based on the detection to the application server.

11. The system of claim 10, wherein detecting, using the computing device, that the pixel is presenting the first color comprises:
detecting, using a browser module of the computing device, that the pixel is presenting the first color.

12. The system of claim 11, wherein detecting, using the browser module of the computing device, that the pixel is presenting the first color comprises:
detecting, using an application programming interface of the browser module of the computing device, that the pixel is presenting the first color.

13. The system of claim 10, wherein the operations further include:
outputting, using a browser module of the computing device, at least a portion of a webpage including a region representing a second color, wherein the video is configured to be overlaid on the second color of the region on the display screen.

14. The system of claim 10, wherein the operations further include:
monitoring, using a browser module of the computing device, a color presented by the pixel.

15. The system of claim 10, wherein the operations further include:
detecting a position of a cursor presented on the display screen, the position being proximate to a position of the pixel; and
monitoring, using a browser module of the computing device, a color presented by the pixel in response to detecting the position of the cursor presented on the display screen.

16. The system of claim 10, wherein the operations further include:
recording, using the computing device and in response to the detection, the first color being presented by the pixel.

17. The system of claim 10, wherein outputting, using the computing device, the video to the pixel of the display screen associated with the computing device comprises:
outputting, using an operating system of the computing device, the video to the pixel of the display screen associated with the computing device.

18. The system of claim 10, wherein the video includes only one image frame.

19. The system of claim 10, wherein the video is configured to play in a loop.

20. A method comprising:
receiving, using a computing device, a video from an application server, wherein the video includes an image frame representing a color, and wherein the video is associated with a digital rights management technology and a resolution of one pixel by one pixel;
forming, using a browser module of the computing device, a HyperText Markup Language (HTML) element including the video received from the application server;
outputting, using an operating system of the computing device, the video of the HTML element to a pixel of a display screen associated with the computing device;
detecting, using an application programming interface of the browser module, that the pixel is presenting the color, wherein the detection represents that the digital rights management technology is disabled on the computing device; and
transmitting, using the computing device, a notification based on the detection to the application server.
